(19) United States
(12) Patent Application Publication
(10) Pub. No.: US 2014/0011553 A1
(43) Pub. Date: Jan. 9, 2014

(54) ANTENNA DEVICE AND A PORTABLE RADIO COMMUNICATION DEVICE COMPRISING SUCH AN ANTENNA DEVICE

(71) Applicant: Laird Technologies AB, Kista (SE)

(72) Inventors: Andrei Kaikkonen, Jarfalla (SE); Peter Lindberg, Uppsala (SE); Lukasz Grynczel, Upplands Vasby (SE)

(73) Assignee: Laird Technologies AB, Kista (SE)

(21) Appl. No.: 13/964,213

(22) Filed: Aug. 12, 2013

Related U.S. Application Data
(63) Continuation of application No. PCT/EP2011/053849, filed on Mar. 15, 2011.

(51) Int. Cl. H04M 1/02

(52) U.S. Cl. CPC H04M 1/026
USPC 455/575.7

(57) ABSTRACT

Exemplary embodiments are disclosed of antenna devices for portable radio communication devices. In an exemplary embodiment, there is an antenna device for a portable radio communication device adapted for receiving radio signals in at least one frequency band. The antenna device includes a radiating element having a first branch and a second branch connected to a common elongated feeding section.

### CROSS-REFERENCE TO RELATED APPLICATION

This application is a continuation of PCT International Application No. PCT/EP2011/053849 filed on Mar. 15, 2011 (published as WO 2012/123021 on Sep. 20, 2012). The entire disclosure of the above application is incorporated herein by reference.

### FIELD

The present disclosure relates generally to antenna devices and more particularly to an antenna device for a portable radio communication device, such as a mobile phone, comprising a radiating element having two branches.

### BACKGROUND

This section provides background information related to the present disclosure which is not necessarily prior art.

Internal antennas have been used for some time in portable radio communication devices. There are a number of advantages connected with using internal antennas, of which can be mentioned that they are small and light, making them suitable for applications wherein size and weight are of importance, such as in mobile phones.

But the application of internal antennas in a mobile phone puts some constraints on the configuration of the antenna device. In particular, in a portable radio communication device, the space for an internal antenna device is limited. These constraints may make it difficult to find a configuration of the antenna that provides for desired operating band coverage.

Further, a portable radio communication device is today many times required to be provided with multiple frequency band coverage for a plurality of cellular operational frequency bands, such as GSM850, GSM900, GSM1800, GSM1900, and WCDMA, as well as a plurality of non-cellular operational frequency bands, such as GPS, BT, and FM. A portable radio communication device has limited space, and it is thus desirable to add multiple frequency band coverage to an antenna device.

For GPS operation in e.g., a mobile phone, there exist requirements for the mobile phone to receive right-hand circularly polarized signals as well as left-hand circularly polarized signals and a quota therebetween. It is thus desirable for an antenna device in a mobile phone to provide functionality fulfilling such requirements.

### SUMMARY

This section provides a general summary of the disclosure, and is not a comprehensive disclosure of its full scope or all of its features.

Exemplary embodiments are disclosed of antenna devices for portable radio communication devices. In an exemplary embodiment, there is an antenna device for a portable radio communication device adapted for receiving radio signals in at least one frequency band. The antenna device includes a radiating element having a first branch and a second branch connected to a common elongated feeding section.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration showing an antenna device according to a first embodiment.

FIG. 2 is a schematic illustration showing a first position of an antenna device in a portable radio communication device.

FIG. 3 is a schematic illustration showing a second position of an antenna device in a portable radio communication device.

Corresponding reference numerals indicate corresponding parts throughout the several views of the drawings.

### DETAILED DESCRIPTION

Example embodiments will now be described more fully with reference to the accompanying drawings.

Exemplary embodiments are disclosed of an antenna device for a portable radio communication device, which can be configured to facilitate reception of circularly polarized signals, as well as be configured to facilitate reception of at least two separate operation frequency bands. A portable radio communication device comprising an antenna device having two branches is also provided.

In an exemplary embodiment, there is provided an antenna device for a portable radio communication device adapted for receiving radio signals in at least one frequency band. The antenna device comprises a radiating element having a first branch and a second branch connected to a common elongated feeding section. The first branch comprises a first elongated section in a first end connected to a first end of the common elongated feeding section, a second elongated section in a first end connected to a second end, opposite the first end, of the first section of the first branch, and a third elongated section in a first end connected to a second end, opposite the first end, of the second section of the first branch and in a second end, opposite the first end, of the third section of the first branch being open ended. The first and third sections of the first branch are essentially parallel. The second branch comprises a first elongated section in a first end connected to a mid-portion of the common elongated feeding section, a second elongated section in a first end connected to a second end, opposite the first end, of the first section of the second branch, and a third elongated section in a first end connected to a second end, opposite the first end, of the second section of the second branch and in a second end, opposite the first end, of the third section of the second branch being open ended. The first and third sections of the second branch are essentially parallel. The first section of the second branch is between the third section of the second branch and the third section of the first branch. The first branch at least partly surrounds the second branch. Such an antenna device can easily be configured to receive both GPS frequencies as well as BT frequencies, and can easily be configured to receive both right-hand side circularly polarized signals as well as suppress left-hand side circularly polarized signals in the upper hemisphere.

The first section of the first branch is preferably arranged essentially perpendicularly to the feeding section. The first section of the second branch is preferably arranged essentially perpendicularly to the feeding section, to further facilitate reception of circularly polarized signals.

The antenna device is advantageously arranged off-ground in the portable radio communication device, to facilitate broad band coverage. When available off-ground space is particularly sparse, the antenna device is preferably arranged on-ground in the portable radio communication device.

With regard to the term radiating element as used herein, it is to be understood that this term is intended to cover electrically conductive elements arranged for receiving and/or transmitting radio signals.

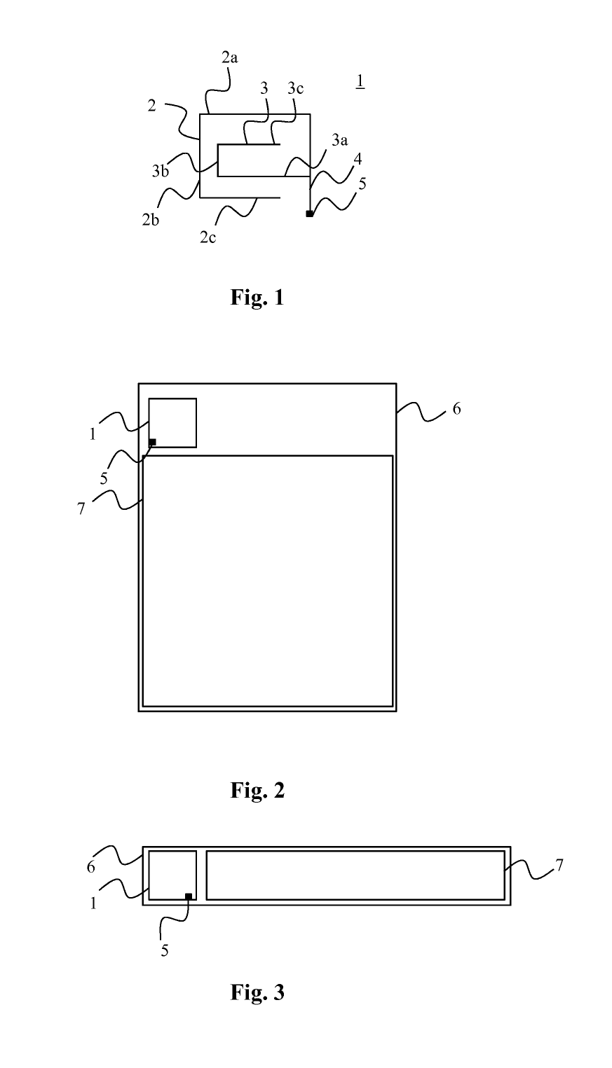

An antenna device for a portable radio communication device according to a first embodiment will now be described with reference to FIGS. 1, 2, and 3. The portable radio communication device 6 may e.g., be a mobile phone, a smart phone, a PDA, a portable computer or similar device, and will in this embodiment be described as a mobile phone.

The antenna device 1 is arranged in a mobile phone 6 adapted for receiving radio signals in at least one frequency band. The antenna device 1 includes a radiating element having a first branch 2 and a second branch 3 connected to a common elongated feeding section 4.

The first branch 2 comprises first, second, and third elongated sections 2a, 2b, and 2c. The first elongated section 2a in a first end is connected to a first end of the common elongated feeding section 4. The second elongated section 2b in a first end is connected to a second end, opposite the first end, of the first section 2a of the first branch 2. The third elongated section 2c in a first end is connected to a second end, opposite the first end, of the second section 2b of the first branch 2 and in a second end, opposite the first end, of the third section 2c of the first branch 2 is open ended. The first and third sections 2a and 2c of the first branch 2 are essentially parallel. This first branch 2 can be seen as a C (e.g., generally C-shaped, etc.) connected to the feeding section 4.

The second branch 3 comprises first, second, and third elongated sections 3a, 3b, and 3c. The first elongated section 3a in a first end is connected to a mid-portion of the common elongated feeding section 4. The second elongated section 3b in a first end is connected to a second end, opposite the first end, of the first section 3a of the second branch 3. The third elongated section 3c in a first end is connected to a second end, opposite the first end, of the second section 3b of the second branch 3 and in a second end, opposite the first end, of the third section 3c of the second branch 3 is open ended. The first and third sections 3a and 3c of the second branch 3 are essentially parallel. This second branch 3 can also be seen as a C (e.g., generally C-shaped, etc.) connected to the feeding section 4. The term mid-portion of the feeding section 4 is merely meant a portion between the respective ends of the feeding section.

The first branch 2 at least partly surrounds the second branch 3. The antenna device can be seen as a double C radiator.

The first section 3a of the second branch 3 is between the third section 3c of the second branch 3 and the third section 2c of the first branch 2. The antenna device 1 can with this configuration be seen as antiparallel C radiators combined into a single radiator. Antiparallel is meant that the currents in the first branch 2 are essentially in anti-phase with the currents in the second branch 3.

The feeding point 5 of the antenna device is in a second end, opposite the first end of the feeding section 4. A fictitious extension of the third section 2c of the second branch preferably crosses the feeding section 4.

The first section 2a of the first branch 2 is arranged essentially perpendicularly to the feeding section 4. The first section 3a of the second branch 3 is arranged essentially perpendicularly to the feeding section 4.

In a typical user configuration for a mobile phone, the antenna device is configured for receiving right-hand side circularly polarized signals in the upper hemisphere, and to suppress left-hand side circularly polarized signals in the upper hemisphere, by the first branch 2 being open-ended in an anti-clockwise circular direction and the second branch 3 being open-ended in a clockwise circular direction.

The antenna device is configured to, in the at least one frequency band, include a GPS operating frequency band, by the first branch 2 having a size of about 14×7 millimeters squared (mm²) and a volume of about 0.27 centimeters cubed (cm³). The length of the first branch 2 is preferably predefined for tuning of the center frequency for the at least one frequency band GPS.

The antenna device is preferably also adapted for receiving radio signals in a second separate frequency band, including a BT operating frequency band, by the second branch 3 having a size of about 12×5 mm², and a volume of about 0.27 cm³. The length of the second branch 3 is preferably predefined for tuning of the center frequency for the second frequency band BT.

The distance between the first branch 2 and the second branch 3 is preferably predefined to tune the separating frequency between the center frequency of the at least one frequency band and the second separate frequency band.

The antenna device is advantageously arranged off-ground in the mobile phone 6. The mobile phone 6 often has a large display having a shielding device 7 covering most of the back side part of the mobile phone 6. The antenna device 1 is advantageously arranged in the top left corner of the mobile phone 6, as seen from its back-side, which position is illustrated in FIG. 2. In this way hand, finger position of a user of the mobile phone is likely not to cover the GPS antenna.

In a further advantageous position, illustrated in FIG. 3, the antenna device 1 is positioned in the top most part of the left side of a mobile phone 6. The view of FIG. 3 is from the left-hand side of a mobile phone, having its top side to the left in the drawing.

Alternatively, if the available off-ground space of a mobile phone is not enough for the antenna device, it is instead arranged on-ground in the portable radio communication device (not illustrated).

Preferred embodiments of an antenna device according to the present disclosure have been described. However, the person skilled in the art realizes that these can be varied within the scope of the appended claims without departing from the inventive idea.

It is realized that the shape and size of the antenna device according to the present disclosure can be varied within the scope defined by the appended claims. Thus, the exact antenna configurations can be varied so as to correspond to the shape of the radio communication device, desired performance, etc.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna device for a portable radio communication device adapted for receiving radio signals in at least one frequency band, the antenna device comprising a radiating element having a first branch and a second branch connected to a common elongated feeding section, wherein:
the first branch comprises:
a first elongated section in a first end connected to a first end of the common elongated feeding section,
a second elongated section in a first end connected to a second end, opposite the first end, of the first section of the first branch, and
a third elongated section in a first end connected to a second end, opposite the first end, of the second section of the first branch and in a second end, opposite the first end, of the third section of the first branch being open ended,
the first and third sections of the first branch being essentially parallel,
the second branch comprises:
a first elongated section in a first end connected to a mid-portion of the common elongated feeding section,
a second elongated section in a first end connected to a second end, opposite the first end, of the first section of the second branch, and
a third elongated section in a first end connected to a second end, opposite the first end, of the second section of the second branch and in a second end, opposite the first end, of the third section of the second branch being open ended,
the first and third sections of the second branch being essentially parallel,
the first section of the second branch is between the third section of the second branch and the third section of the first branch, and
the first branch at least partly surrounds the second branch.

2. The antenna device as claimed in claim 1, comprising a feeding point in a second end, opposite the first end of the feeding section.

3. The antenna device according to claim 1, wherein:
the first section of the first branch is arranged essentially perpendicularly to the feeding section, and
the first section of the second branch is arranged essentially perpendicularly to the feeding section.

4. The antenna device according to claim 3, wherein the antenna device is configured for receiving right-hand side circularly polarized signals and for suppressing left-hand side circularly polarized signals in the upper hemisphere.

5. The antenna device as claimed in claim 4, wherein the at least one frequency band includes a GPS operating frequency band.

6. The antenna device as claimed in claim 5, adapted for additionally receiving radio signals in a second separate frequency band, preferably including a BT operating frequency band.

7. A portable radio communication device comprising an antenna device according to claim 6.

8. The portable radio communication device as claimed in claim 7, wherein the antenna device is arranged off-ground in the portable radio communication device.

9. The portable radio communication device as claimed in claim 7, wherein the antenna device is arranged on-ground in the portable radio communication device.

10. The antenna device according to claim 1, wherein the antenna device includes a configuration of antiparallel C radiators combined into a single radiator.

11. A portable radio communication device comprising an antenna device according to claim 1.

12. The portable radio communication device as claimed in claim 11, wherein the antenna device is arranged off-ground in the portable radio communication device.

13. The portable radio communication device as claimed in claim 11, wherein the antenna device is arranged on-ground in the portable radio communication device.
